(19) United States
(12) Patent Application Publication
(10) Pub. No.: US 2026/0131875 A1
(43) Pub. Date: May 14, 2026

(54) Boat mooring hull protection

(71) Applicant: Rory Townsend-Seddon, Hove (GB)

(72) Inventor: Rory Townsend-Seddon, Hove (GB)

(21) Appl. No.: 19/119,783

(22) PCT Filed: Oct. 13, 2023
(86) PCT No.: PCT/GB2023/052659

§ 371 Date: Apr. 10, 2025

(30) Foreign Application Priority Data
Oct. 13, 2022 (GB) 2215156.7

(51) Int. Cl. B63B 59/04; B32B 5/02; B32B 27/12; B32B 27/32

(52) U.S. Cl. CPC B63B 59/045; B32B 5/024; B32B 27/12; B32B 27/32; B32B 2255/02; B32B 2255/26; B32B 2262/0238; B32B 2262/101

(57) ABSTRACT

A boat/vessel mooring system to prevent marine growth to hull when boat is moored up and stationary. Invention envelopes vessel and prevents marine growth by reducing water flow around hull, thus removing a suitable growing environment.

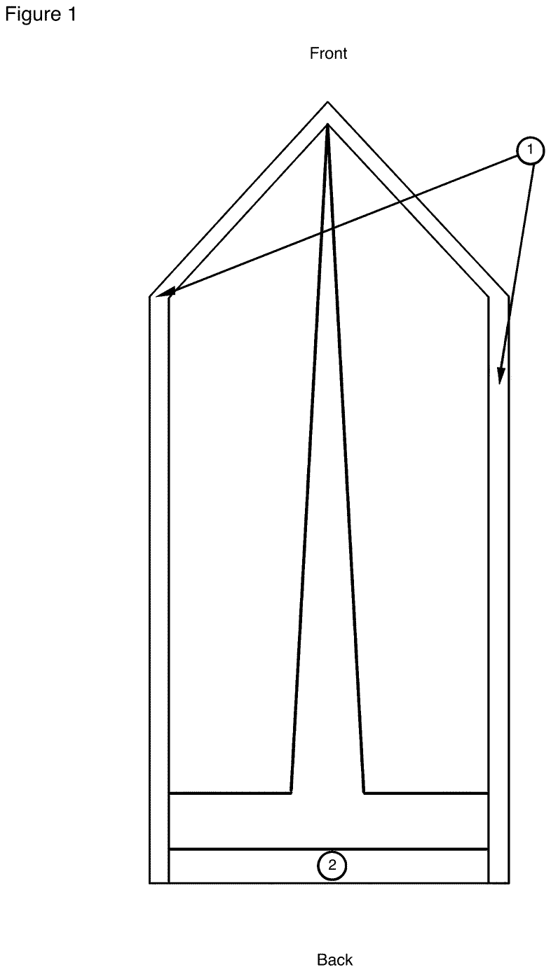

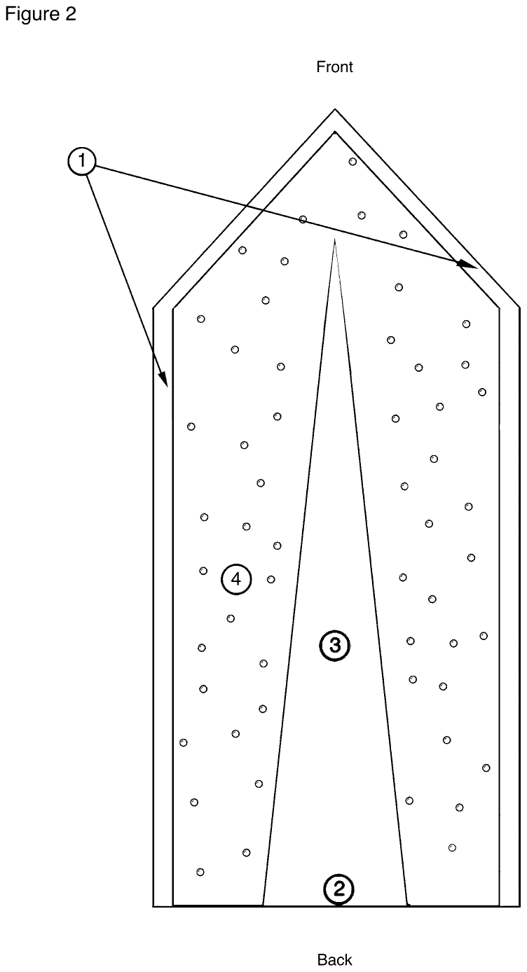

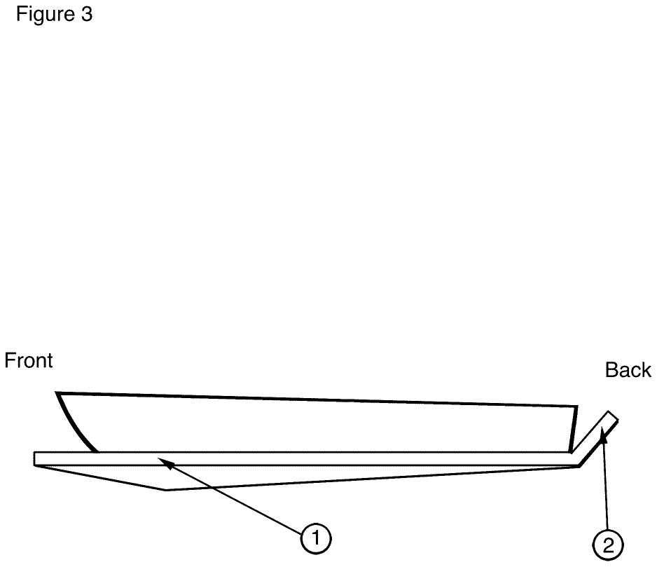

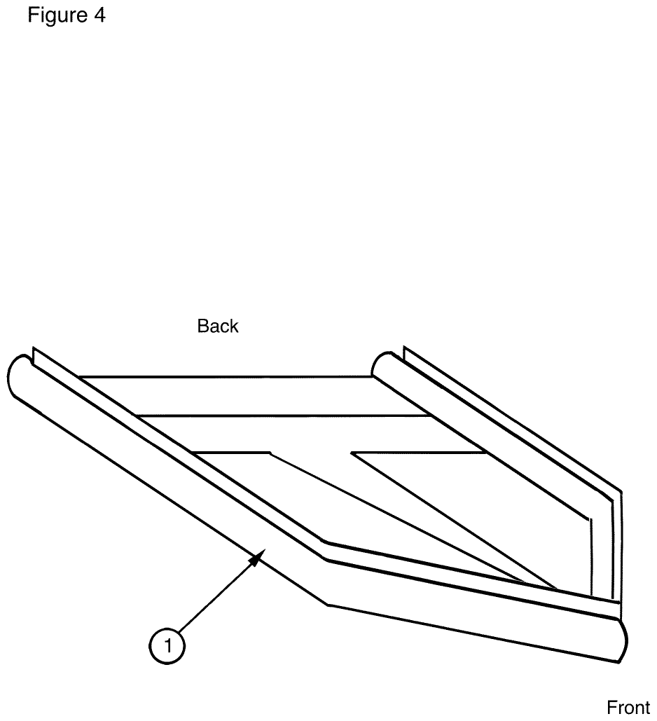

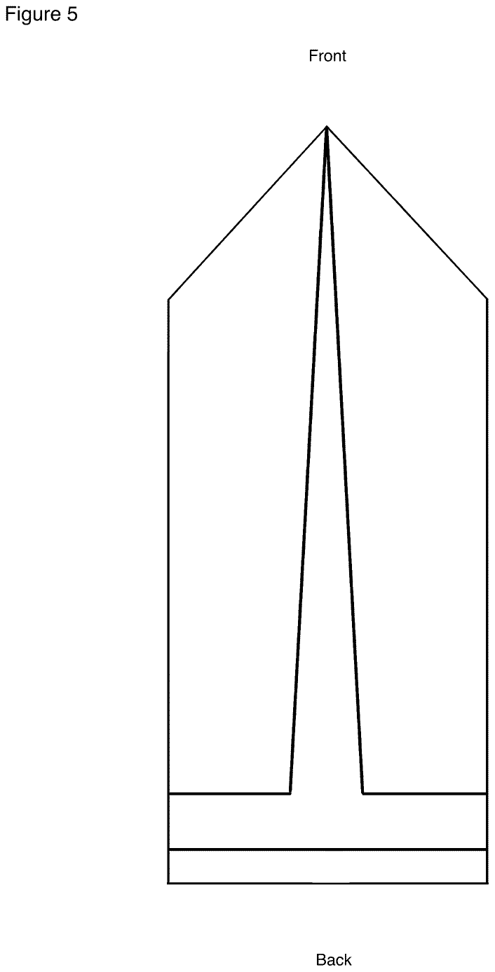

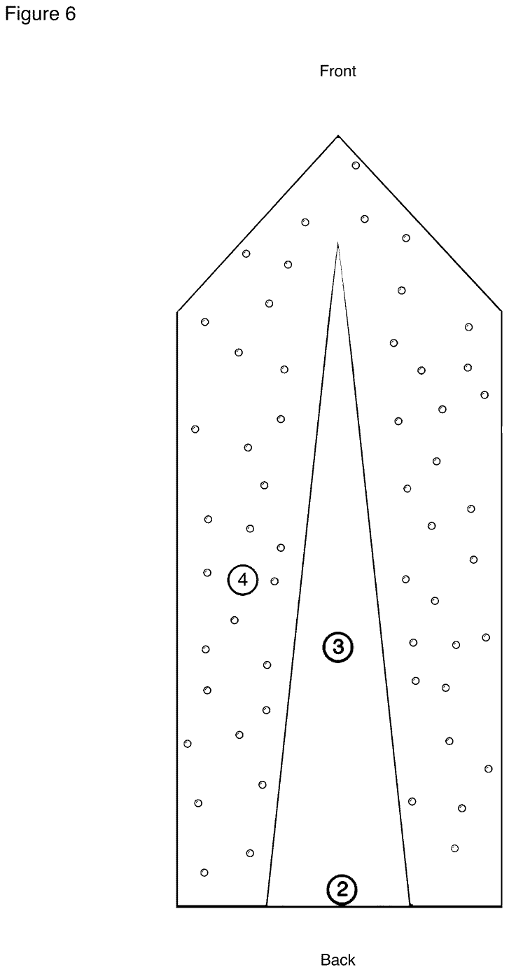

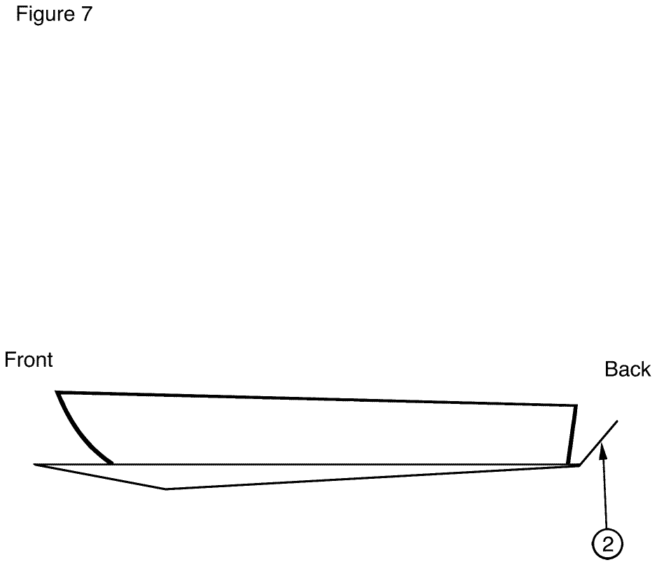

### FIELD OF INVENTION

A floating flexible assembly that protects a boat hull from marine growth whilst moored.

### BACKGROUND

Boats moored on water attract organisms and marine life to grow on the hull when the vessel is static for more than three days. The invention is designed to prevent such growth whilst the boat is docked on top of it. This negates the need to apply anti-fouling products to be applied to the vessel hull or ancillaries.

Existing products on the market, with a similar mechanism, either involve a more complex operation or are too lightweight to allow easy entry without buckling for a variety of shaped hulls.

### STATEMENT OF INTENTION

The invention is a floating flexible protector assembly that is made up of at least 2 layers*. An upper layer with a density higher than the density of the water it is to be used in, typically PVC material, and a lower layer of sufficiently low density that the entire construction floats on. The lower layer provides buoyancy, on the water, to the upper layer pressing against vessel hull.

*An additional layer of higher density, than water, may be added underneath the lower density layer to provide additional shear and impact resistance to the invention.

The protector is attached to the boat mooring. A boat floats onto the protector from the back and stops when the hull is fully covered. The back edge of the protector is manually lifted once the boat is docked and secured. The raised back section prevents additional water entering the invention which further stops marine growth forming on the boat transom and rear ancillaries. The protector envelops the boat hull from underneath starving oxygen, nutrients and light to marine life, thus preventing marine growth. Any excess water is advised to be drained from the invention, by means of an additional pump, as to minimise marine growth further.

The protector can also have the option of low density rods that run along both long edges and the front edge. The low density rods run the length and front edge of the invention and are fitted inside fabric channel sleeves. The rods provide structure, additional floatation to the invention and prevent buckling as the boat glides onto sheet and act as a water barrier.

The protector has multiple eyelets fixed along the outer edge to allow securing to a various moorings via rope.

The upper layer is supported on the surface of the water by a low density layer underneath. The low density layer has a triangular section removed that is wider at back of the protector and tapers to a point towards the front. The shape mimics the shape of a hull. The cutout allows the protector to be submerged along the centre line in a typical boat hull shape. The submerged area allows the boat to glide on the water onto the protector with minimal resistance.

Existing products on the market involve either:
A. fully submerging the main sheet with only the edge of the product providing floatation by way of an inflatable tube or large foam tubes. This requires a more complex operation that requires mechanical or electrical assistance in closing off water supply to hull. The fully submerged sheet does not press against the hull due to lack of sheet buoyancy, allowing water to flow around the hull and marine growth to occur.
B. an alternative product requires manually forcing the product down upon steeper hulled boat entry as it is too lightweight and has no central flotation triangular cutout to allow easy entry without buckling for a variety of shaped hulls. The product does not utilise a means of preventing water from circulating the hull, allowing marine life to grow.
C. involve more complexity by raising the boat out of the water by means of mechanical lifts or compressed air

### Statements

1. A protector comprising a rectangular rear portion and tapered front portion for the hull of a waterborne vessel in the water, the protector comprising a sheet having at least two layers, a first layer with a density higher than the density of water, and a second layer with a density lower than the density of water, wherein when the protector is in use the second layer provides buoyancy to the first layer and presses the first layer against the waterborne vessel hull, the second layer having a triangular cut out arranged along the centreline, tapering towards the front of the protector, to allow the first layer to be submerged for waterborne vessel entry.
2. A protector according to statement 1, wherein made with a top layer of woven glass fibre sealed with a polymer coating.
3. A protector according to statement 1, wherein made with a top layer of PVC fabric and a lower layer of LDPE.
4. A protector according to statement 1, wherein an additional layer of PVC fabric is fixed beneath the lower density layer.
5. A protector according to any preceding statement, wherein an additional sacrificial wear layer of PVC fabric is fixed above the first layer.
6. A protector according to any preceding statement, wherein pockets/channels created from the same material as the first layer, surround three edges of the sheet, are filled with low density foam rods of greater height than the first layer to provide a vertical water barrier and additional rigidity to structure.

1. A protector comprising a rectangular rear portion and tapered front portion for the hull of a waterborne vessel in the water, the protector comprising a sheet having at least two layers, a first layer with a density higher than the density of water, and a second layer with a density lower than the density of water, wherein when the protector is in use the second layer provides buoyancy to the first layer and presses the first layer against the waterborne vessel hull, the second layer having a triangular cut out arranged along the centreline, tapering towards the front of the protector, to allow the first layer to be submerged for waterborne vessel entry.

2. A protector according to claim 1, wherein made with a top layer of woven glass fibre sealed with a polymer coating.

3. A protector according to claim 1, wherein made with a top layer of PVC fabric and a lower layer of LDPE.

4. A protector according to claim 1, wherein an additional layer of PVC fabric is fixed beneath the lower density layer.

5. A protector according to any preceding claim, wherein an additional sacrificial wear layer of PVC fabric is fixed above the first layer.

6. A protector according to any preceding claim, wherein pockets/channels created from the same material as the first layer, surround three edges of the sheet, are filled with low density foam rods of greater height than the first layer to provide a vertical water barrier and additional rigidity to structure.
